(19) United States
(12) Patent Application Publication
(10) Pub. No.: US 2010/0146934 A1
(43) Pub. Date: Jun. 17, 2010

(54) Hot Gas Chamber

(75) Inventor: Peter LUGER, Wurmannsquick (DE)

Correspondence Address: CROWELL & MORING LLP;INTELLECTUAL PROPERTY GROUP, P.O. BOX 14300, WASHINGTON, DC, 20044-4300, US

(73) Assignee: Astrium GmbH, Taufkirchen (DE)

(21) Appl. No.: 12/637,398

(22) Filed: Dec. 14, 2009

(30) Foreign Application Priority Data
Dec. 15, 2008 (DE) 102008061917.5-13

(51) Int. Cl. F02K 9/64

(52) U.S. Cl. 60/266

(57) ABSTRACT

A hot gas chamber, such as a combustion chamber for a power unit for the discharge of a hot gas flow, particularly for a rocket propulsion unit, has a combustion chamber wall, which has an internal surface and cooling ducts adjoining the latter. The internal surface of the combustion chamber wall facing the combustion chamber is further developed at least in areas for avoiding a film condensation.

This application claims the priority of German patent document 10 2008 061 917.5-13, filed Dec. 15, 2008, the disclosure of which is expressly incorporated by reference herein.

The present invention relates to a hot gas chamber, and in particular, to a combustion chamber for a power unit for the discharge of a hot gas flow, such as a rocket propulsion unit.

In combustion chambers of this type, normally a cooling device is provided adjoining a combustion chamber wall for the purpose of keeping the combustion chamber wall sufficiently cool relative to the hot combustion gases, such that an acceptable service life of the combustion chamber is achieved. However, in the case of special types of rocket propulsion units, such as regeneratively cooled power units, it is desirable to achieve a higher heat supply into the cooling device because, in such rocket propulsion units, the heat absorbed by the cooling device is used for effective operation of the power unit, for example, for driving fuel pumps.

Like the main portion of the fuel flow, the fuel fraction which drives the fuel pumps (for example, the turbopumps) is subsequently fed into the combustion chamber. In this so-called expander process, the operation of the power unit will be the more effective, the higher the amount of heat absorbed by the cooling device.

Because of this cooling by the liquid fuel, the temperature of the combustion chamber wall is reduced considerably. As a result, the temperature of the internal surface of the combustion chamber wall may drop so far that the water which is formed as a combustion product will condense there in the area of the hot gas flow close to the wall.

On the internal combustion chamber wall, which as a rule consists of copper because of the required high thermal conductivity, the condensed water will form a water film which impedes the heat transfer from the hot gas in the combustion chamber to the cooling medium flowing through the cooling ducts. Furthermore, the water film may detach from the internal combustion chamber wall and be entrained by the hot gas, in which case the water film will then impact on the internal wall of a nozzle adjoining the combustion chamber in the flow direction. In an extreme case, this impact of the detached water film forms a water jet that impacts on the internal nozzle wall, resulting in considerable thermal tensions in the material of the nozzle wall. The nozzle wall may, for example, consist of a ceramic material. As a result of the local cooling effect of the internal nozzle wall caused by the impacting of the water film thereon, damage, such as cracks in the material of the nozzle wall, may occur.

One object of the present invention, therefore, is to provide a hot gas chamber of the above-mentioned type which reduces deterioration of the heat transfer between hot gas and cooling medium caused by the water condensation on the internal combustion chamber wall.

Another object of the invention is to reduce the danger of damage to the nozzle arranged on the output side as a result of the impacting of condensate.

These and other objects and advantages are achieved by hot gas chamber according to the invention, in which the internal surface of the combustion chamber wall facing the combustion chamber, at least in areas, is configured such that film condensation thereon is avoided. As a result, condensation which occurs in the area of the combustion chamber wall does not take place as film condensation, but only as drop-wise condensation. Such drop-wise condensation significantly improves the heat transfer between the hot gas in the combustion chamber and the coolant in the cooling ducts.

Furthermore, the drops of condensate which form on the internal surface of the combustion chamber wall offer a significantly greater application surface for the rapid hot gas flow in the combustion chamber than a closed smooth water film which results from film condensation. The condensate drops forming according to the invention are thereby entrained by the hot gas flow and atomized, so that there will be no local impacting of a water film (or even a water jet) on the internal wall of a nozzle arranged on the output side of the combustion chamber.

Preferably, the area of the internal surface is further developed downstream of the narrowest cross-section of the combustion chamber, for avoiding a film condensation. In the prior art, in this area downstream of the combustion chamber neck it is inevitable that the water film formed by the film condensation will separate and be entrained by the hot gas flow, so that it impacts on the internal nozzle wall. When the surface is formed according to the invention, such that film condensation is avoided, the risk of the separation of larger water accumulations is also avoided.

In a particularly advantageous embodiment of the invention, the internal surface of the combustion chamber wall facing the combustion chamber has a hydrophobic characteristic, at least in areas, in order to avoid film condensation. This hydrophobic surface development prevents the formation of condensate film in this area; rather, at most, drops of condensate accumulate which are immediately entrained again by the hot gas flow and atomized. Advantageously, the hydrophobic area of the internal surface has a hydrophobic coating. In this case, such coatings, which are generally known from process engineering, must be thermally stable and have a sufficient longevity. A coating for achieving the so-called lotus blossom effect is an example.

It is particularly effective for the internal surface of the combustion chamber wall to have a greater roughness underneath the hydrophobic layer than in the area that is not provided with a hydrophobic coating. For this purpose, the wall roughness of the internal chamber wall in the areas to be hydrophobically developed can be increased before the application of the hydrophobic coating. These so-called “super-hydrophobically” developed areas of the combustion chamber wall prevent the formation of a film coating in a particularly effective manner.

Other objects, advantages and novel features of the present invention will become apparent from the following detailed description of the invention when considered in conjunction with the accompanying drawings.

### BRIEF DESCRIPTION OF THE DRAWINGS

FIG. 1 is a view of a rocket propulsion unit with regenerative cooling according to the expander process;

FIG. 2 is an enlarged cross-sectional view corresponding to detail II of FIG. 1;

FIG. 3a is a view of a cutout of the combustion chamber wall area illustrated in FIG. 2 according to detail III in FIG. 2 with an enlarged drop of condensation; and

FIG. 3b is a view of the same area as in FIG. 3a but in the case of a conventional combustion chamber wall without a hydrophobic surface design with a condensate film.

### DETAILED DESCRIPTION OF THE DRAWINGS

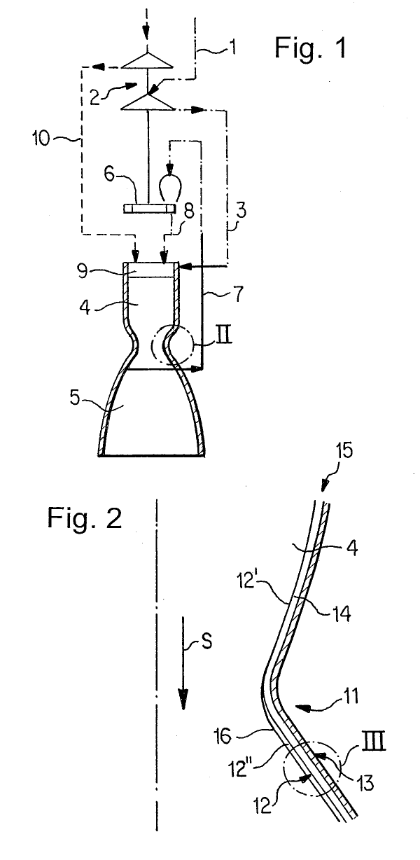

FIG. 1 shows a special type of rocket propulsion unit which operates according to the main flow process without precombustion (also called an expander process). In this case, a first fuel (for example, liquid hydrogen) is fed via a first feed line 1 to a fuel pump 2. A supply line 3 branches off the latter and supplies the first fuel to a cooling device that cools the wall of the combustion chamber 4 (and, as required, also the propelling nozzle 5) of the rocket propulsion unit. Within the scope of the cooling, the first fuel will absorb heat from the combustion chamber 4 (and, as required, from the propelling nozzle 5). A further supply line 7 removes the first fuel, with the thermal energy stored therein, from the combustion chamber. This thermal energy is used to drive a turbine 6 which in turn drives the fuel pump 2. Subsequently, the first fuel is supplied via a supply line 8 to the injection head 9 of the rocket propulsion unit, and injected into the combustion chamber 4 for combustion. The second fuel (for example, liquid oxygen), directly after passing through the fuel pump 2, is supplied via the supply line 10 to the injection head 9 and is also injected into the combustion chamber.

In order to maximize the combustion chamber pressure, and to optimize the effective operation of the power unit, in the above-described power unit, it is necessary that as much heat as possible is absorbed by the first fuel when passing through the cooling device, so that the fuel can enter into the turbine at a temperature that is as high as possible, and a correspondingly high compression of the supplied fuels can be generated in the fuel pumps.

The cross-sectional representation of FIG. 2 is a detailed illustration of an example of the construction of a combustion chamber 4, which has a contraction 11, the so-called combustion chamber neck. Cooling ducts 14 are formed in the combustion chamber wall 15, and a coolant (in the above-mentioned case, a first fuel) flows through the cooling ducts 14. The latter are formed on the back side of the internal surface 12′ of the combustion chamber wall 15 facing away from the hot gas side. For this purpose, the combustion chamber wall 15 has an internal layer 12 with an internal surface 12′ toward the combustion chamber 4, and an external layer 13. The cooling ducts 14 are formed between the internal layer 12 and the external layer 13.

Downstream of the combustion chamber neck 11 in the direction S of the hot gas flow through the combustion chamber 4 (in the direction of the propelling nozzle 5), the internal layer 12 of the combustion chamber wall 15 is provided with a hydrophobic coating 16. The hydrophobic coating 16 is applied to the internal surface 12″ roughened in this area of the combustion chamber wall 15. The surface roughness in the area of the surface 12′ of the combustion chamber wall 15 situated underneath the coating 16 is significantly greater than the roughness of the internal surface 12′ of the combustion chamber wall 15 in the areas not provided with the hydrophobic coating. (Instead of the coating of the combustion chamber wall 15 with a hydrophobic layer 16, any other surface treatment of the combustion chamber wall 15 may also be provided which results in hydrophobic properties of the internal surface of the combustion chamber wall 15.)

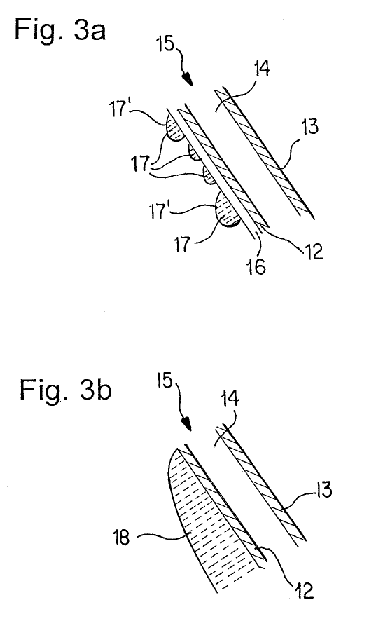

FIG. 3a shows the combustion chamber wall 15 in the area of detail III in FIG. 2. At this point, the internal layer 12 of the combustion chamber wall 15 has the hydrophobic coating 16. The condensate that precipitates at the internal side of the combustion chamber wall 15 on the hydrophobic layer 16 forms a plurality of droplets 17 here, whose respective free surface 17′ forms a sufficient application surface for the hot gas flow flowing past. As a result, these precipitated droplets are entrained by the hot gas and are atomized again.

FIG. 3b shows a comparable area of a combustion chamber wall in a conventional combustion chamber without a hydrophobic coating. There, a condensate film 18 will form on the hydrophilic internal surface of the internal layer 12. In this case, large-surface areas of the condensate film may detach as a result of the forces of the hot gas flow passing by. The condensate film is maintained as a major condensate accumulation, and may impact on the internal surface of the downstream propelling nozzle 5.

Reference symbols in the claims, the description and the drawings are used only for a better understanding of the invention and should not limit the scope of the protection.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SYMBOLS

4 Combustion chamber
11 narrowest cross-section
12′,12″ internal surface
14 cooling ducts
15 combustion chamber wall
16 hydrophobic coating

What is claimed is:

1. A combustion chamber for a power unit for the discharge of a hot gas flow from a rocket propulsion unit having cooling ducts adjoining an internal surface of a combustion chamber wall; wherein:
at least a portion of the internal surface of the combustion chamber wall facing the combustion chamber has surface properties that avoid film condensation.

2. The hot gas chamber according to claim 1, wherein said portion of the internal surface is further developed downstream of a narrowest cross-section of the combustion chamber for avoiding a film condensation.

3. The hot gas chamber according to claim 1, wherein said at least a portion of the internal surface facing the combustion chamber has a hydrophobic construction for avoiding a film condensation.

4. The hot gas chamber according to claim 3, wherein the hydrophobically constructed area of the internal surface is provided with a hydrophobic coating.

5. The hot gas chamber according to claim 4, wherein the internal surface of the combustion chamber wall has a greater roughness underneath the hydrophobic layer than in an area which is not provided with a hydrophobic coating.
